(19) United States
(12) Patent Application Publication
(10) Pub. No.: US 2008/0023507 A1
(43) Pub. Date: Jan. 31, 2008

(54) Spare tire cover having interchangeable graphic displays

(76) Inventor: E. Alan Uebler, Newark, DE (US)

Correspondence Address: E. Alan Uebler, P.A.;E. Alan Uebler, Esq., Lindell Square, Suite 4, 1601 Milltown Road, Wilmington, DE, 19808, US

(21) Appl. No.: 11/493,494

(22) Filed: Jul. 26, 2006

(51) Int. Cl. B62D 43/00

(52) U.S. Cl. 224/42.2

(57) ABSTRACT

A cover for an externally mounted spare tire for a vehicle is provided, the cover having a repository affixed thereto, the repository having at least one opening thereinto and having at least one transparent window therein, and optionally including a removable graphic display which, upon placement within the repository, is displayed externally of the vehicle through the transparent window. Preferred is the complete combination, including the graphic display. The removable, interchangeable graphic display may carry an informative theme, a political theme, a sports or automotive theme, a humorous theme, a religious theme, a photograph, or virtually any other display of one's choosing and capable of representation in two dimensions.

### FIELD OF THE INVENTION

The invention relates to a vehicle spare tire cover having interchangeable graphic displays.

### BACKGROUND OF THE INVENTION

Expressing one's opinion and preferences on many issues arising in daily life, e.g., on political issues, one's preferred sports teams, and on religious matters, to name just a few, is a favorite current pastime of many. Examples abound in election years, at the start of football season, and at patriotic holidays, for instance, as evidenced by the proliferation of bumper stickers affixed to the bumpers and other surfaces of automotive vehicles. Admonitions to “Save the Planet” and variations thereof are a favorite of environmentalists, despite the fact that the very adhesives used to affix the bumper stickers can themselves create environmental problems.

In addition to bumper stickers for vehicles, covers for externally mounted spare tires, typically found on many sports utility vehicles (SUV's) and large recreational vehicles (RV's), are well known, and many such covers have designs incorporated into the covers themselves, such as, for example, the logo of a football team, or the logo of the SUV manufacturer, such as “JEEP”, thereby providing advertising for the manufacturer. A GOOGLE search of the World Wide Web discloses, for example, patriotic emblems, specifically U.S. flag depictions, on spare tire covers useable on vehicle brands such as Hummers, Jeeps, etc., and made by American Stitchco, Inc., located in Mountain Home, Ariz.

Conventional soft, flexible spare tire covers, often made of vinyl plastic, are moderately expensive, typically costing in the range of $15-50 (retail). In addition to covering the unsightly spare tire and wheel mounted externally on the rear of a sometimes quite expensive and otherwise elegant vehicle, these covers tend to preserve and protect the spare tire itself.

Soft covers for spare tires are generally installed by wrapping over the tire and being secured thereto by an elastic cord or ties positioned at the inner, back side of the mounted tire. Soft and flexible covers are generally light in weight, and are quickly and easily affixed about the spare tire. Hard-shelled covers are available for some vehicles, but such covers are less popular owing to their much higher cost. The principles of this invention, however, where applicable and as will be known to those skilled in the art, apply equally well to both hard-shell covers and soft, flexible covers.

Conversely, bumper stickers are inexpensive, typically costing in the range of $0.50-3.00 (retail).

Typical spare tire covers having logos thereon are constructed as an integral unit, with the logo painted, embossed, screened or embroidered, for example, into the cover. To change the thought or theme expressed therein requires purchasing an entire new cover. For comparison, the cost of a custom made spare tire cover incorporating one's personalized display thereon, such as a photograph, can exceed $250 (retail).

Bumper stickers, while inexpensive, are adhesively applied. To change the thought or theme thereon, the sticker must be peeled off, often leaving an unsightly and difficult-to-remove and environmentally unfriendly residue. A new theme is then adopted by sticking on a new sticker.

There potentially is a need for inexpensively combining the message or theme-delivering capability of a bumper sticker with a spare tire cover for a vehicle, in such manner that the expressed message or theme is readily, easily and substantially instantaneously changeable by the vehicle's owner, at his whim, all at low cost and having no adverse environmental impact.

The combination is achieved by the invention disclosed and claimed herein.

### SUMMARY OF THE INVENTION

A cover for an externally mounted spare tire for a vehicle is provided, the cover having a repository affixed thereto, the repository having at least one opening thereinto and having at least one transparent window therein, and optionally including a removable graphic display which, upon placement within the repository, is displayed externally of the vehicle through the transparent window. Obviously preferred is the complete combination including the graphic display. The repository may be an envelope having at least one transparent panel, the envelope being affixed to the cover externally thereof such that the display is removably insertable into the envelope through the opening therein. The envelope may be adhesively affixed to the cover, affixed by mechanical means, affixed by thermal means, or by any other suitable attachment means.

The transparent window may alternatively be formed of a single transparent panel affixed externally to the cover about the periphery of the panel leaving an opening through which the display may be inserted, with the panel thereby forming a pocket in the cover holding the display. The panel may be adhesively affixed to the cover, affixed by mechanical means, or by thermal or any other suitable means.

In a further alternative embodiment, the cover-repository-display combination of the invention has at least one transparent panel affixed externally to the cover about the entire periphery of the panel, and the cover has an opening therein positioned within the peripheral boundary of the panel, which opening extends from the inside of the cover through the cover and into the repository formed between the external transparent panel and the cover. This opening permits removable insertion of the display into the repository only from within the (disassembled) tire cover, and this embodiment deters theft of the display from the repository. The opening may be a slit or a slot, and it may have a closure therefor such as a zippered closure, the well-known “zip lock” type of closure, or a “Velcro” closure, for example.

In all embodiments, the transparent window is preferably constructed of transparent plastic such as, without limitation, polyethylene, polypropylene, vinyl, acrylic and polyester plastic. The display may be fixed on a placard which is removably insertable into the repository, and the display may be at least partially reflective or fluorescent. The placard may be constructed of heavy gage plastic having indicia printed thereon, or of cardboard, or of heavy weight paper, or of any other suitable material capable of carrying a graphic image thereon.

The graphic display may carry an informative theme, a political theme, or a sports or automotive theme, a humorous theme, a religious theme, a photograph, or virtually any other display of one's choosing and capable of representation in two dimensions.

### BRIEF DESCRIPTION OF THE DRAWINGS

In the accompanying drawings:

FIG. 1 depicts one embodiment of the vehicle spare tire cover-repository-display combination of the invention, in perspective, mounted upon a spare tire of an otherwise conventional, generic, sports utility vehicle (SUV);

FIG. 2 is a side elevation, partially in cross-section, of the tire cover-repository-display combination of the invention illustrating an envelope type repository affixed to a tire cover according to the invention;

FIG. 3 depicts a whimsical “smiley face” graphics display on a placard which is insertable into the repository affixed to the tire cover, all according to the principles of the invention;

FIG. 4 shows, in cross-section, an alternate embodiment of a combination cover-repository-display of the invention affixed to a tire, wherein the repository is accessible only from the inside of the cover, that is, through an opening extending from the inside of the installed tire cover into the repository, thereby prohibiting easy access to the graphics display externally of the vehicle and providing a deterrence to theft of the display;

FIG. 5 is an elevational perspective view, partially broken away, of the combination depicted in FIG. 4 taken substantially along line 5-5 of FIG. 4;

FIG. 6 is a familiar display of a sports team logo which may be displayed as the graphics display (with permission of the owner of such logos);

FIG. 7 is a depiction of a possible humorous phrase which may form the display of the invention;

FIG. 8 depicts an envelope type repository affixed to a tire cover according to the invention, wherein the envelope has a flap-type closure having a zippered-type closing means;

FIG. 9 shows an envelope type repository affixed to a tire cover wherein an opening extends from inside the cover into the repository through which a graphics display can be inserted;

FIG. 10 shows a single transparent panel affixed to a tire cover by adhesive, thermal welding or other means, the assembly having an opening from the inside of the tire cover into the repository space between the panel and the cover through which opening the graphics display is inserted into the repository to effect display of the graphics thereon from the rear of the vehicle.

### DETAILED DESCRIPTION OF THE INVENTION AND PREFERRED EMBODIMENTS WITH REFERENCE TO THE DRAWINGS

A cover for an externally mounted spare tire for a vehicle is provided, the cover having a repository affixed thereto, the repository having at least one opening thereinto and having at least one transparent window therein, and optionally including a removable graphic display which, upon placement within the repository, is displayed externally of the vehicle through the transparent window. Preferred is the complete combination, including the graphic display. The removable, interchangeable graphic display may carry an informative theme, a political theme, a sports or automotive theme, a humorous theme, a religious theme, a photograph, or virtually any other display of one's choosing and capable of representation in two dimensions.

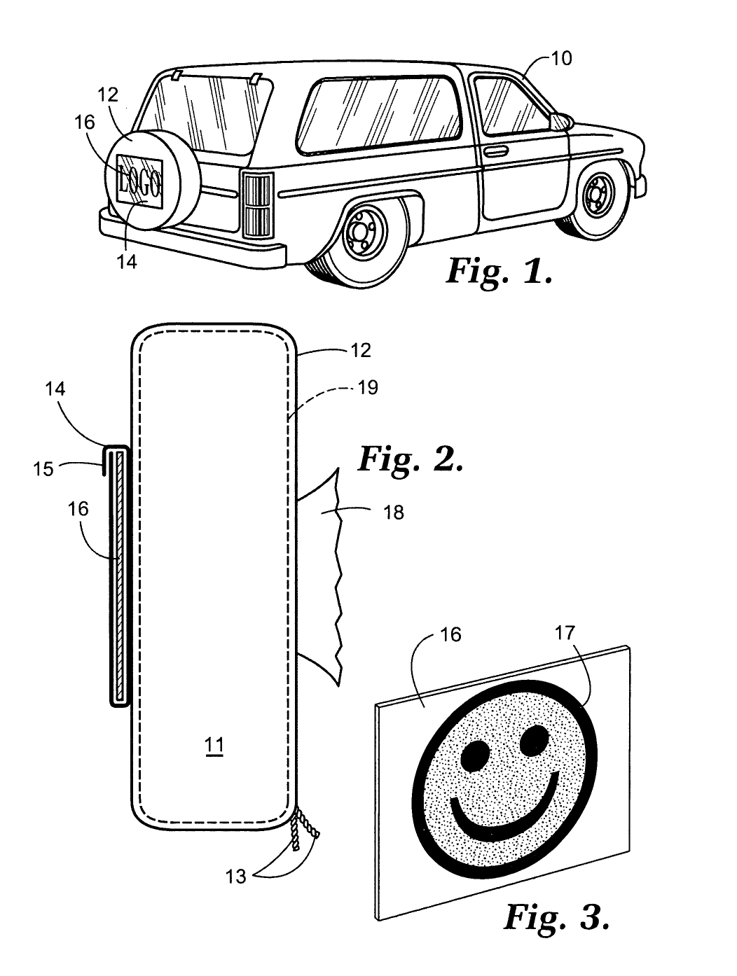

A detailed description of the invention and preferred embodiments is best provided with reference to the accompanying drawings wherein FIG. 1 depicts a generic sports utility vehicle (SUV) 10 having a spare tire (not seen) mounted on the rear thereof. The spare tire itself is covered by a cover 12 having affixed thereto a transparent panel 14 through which an inserted graphics display 16, indicated by “LOGO”, is displayed and visible from the rear of the vehicle 10 as shown.

FIG. 2 is a side elevational view of the spare tire cover-repository-display combination of the invention covering spare tire 11 mounted on vehicle 10 by mounting means 18, wherein the cover 12, having inside surface 19 (shown for completeness), has an envelope type repository 14 affixed to the outside of the cover 12. The envelope 14 may be made entirely of a transparent plastic, or may have a transparent panel facing rearwardly. The envelope 14 has optional closure 15, which may be a flap as shown. A graphic display 16, of one's choice, is inserted through the upper, flapped opening and into the repository 14 as shown. Pull ties 13, or elastic cords, may be used to keep the cover 12 snug over the tire 11, as with conventional tire covers.

FIG. 3 depicts one possible graphic display 16, i.e., a placard 16 with a “smiley face” 17 displayed thereon.

Possible such displays clearly include any two-dimensional representation of anything which is capable of being depicted in two dimensions. Preferred displays may be informative, such as advertising for the particular vehicle or the dealership from which it was purchased, or they may carry a political theme, or promote a sports theme or an automotive (“NASCAR”) theme, display a photograph, carry a religious theme, or depict a humorous phrase. Those old enough may recall and reminisce on humorous “Burma Shave” highway signs of the 1940's and 1950's, where the sometimes tedious monotony of long distance driving was interspersed with tension-relieving humor of “Burma Shave” parables and advertisements. Such road humor is also available here.

A particular advantage of the invention resides in the fact that the display theme may be changed, quickly and at will or whim. The sports fan can display a baseball theme in summer and a football theme in the fall. Political assertions and preferences may be addressed and varied for different election cycles. And suitable original displays may be created on one's home PC printer, providing placard displays generally of a size of 11×17 inches or less. The possibilities for adopting a preferred display at any given time are, in fact, endless.

Referring again to FIG. 2, the envelope or other repository 14 may be made of any suitable material, all known to those skilled in this art. Preferred materials include transparent plastics, the repository having at least one transparent panel therein of such material, although the entire envelope 14 may be a transparent plastic envelope. Suitable plastics can include, without limitation, polyethylene, polypropylene, vinyl, acrylic and polyesters.

The display inserts 16 also may be made of several suitable materials known to those skilled in the art, on which graphic displays have heretofore been placed, by means such as printing or screening or the like, such as plastic, paper, cardboard, or other similar substrate.

The repository component of the invention 14 may be affixed to the tire cover 12 of the invention by suitable attachment means, also known to those skilled in the art, which may vary depending on the materials of construction employed. Among the possible attachment means are included adhesive means, mechanical means, i.e., stitching, and thermal means. The latter, thermal welding, is especially suitable when employing thermoplastic repository materials affixed to synthetic plastic, i.e., vinyl, tire covers. However, it will be clear that any suitable means of attachment may be used, and will fall within the scope of the appended claims, as long as the objective of the rearward display of the desired graphic in the cover-repository-display is achieved as described herein.

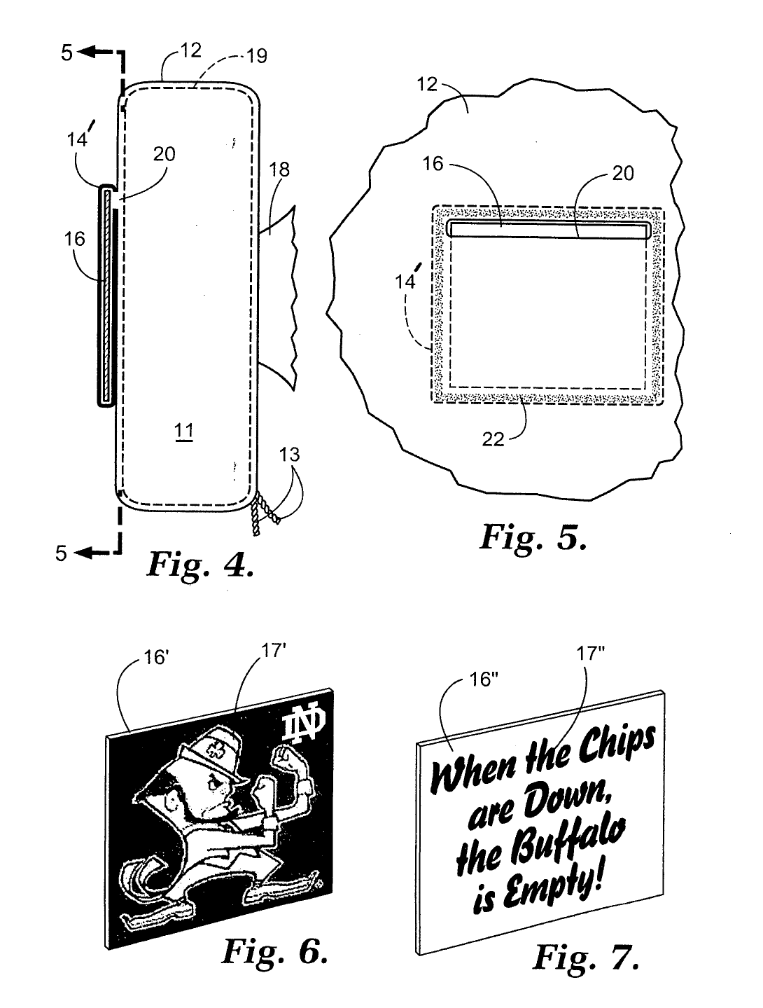

FIG. 4 shows an embodiment of the cover-repository-display combination of the invention wherein, once assembled and oriented to display the logo 17, the graphic display can not be accessed externally of the vehicle without removing the cover completely from the tire. Human nature being what it is, such an embodiment may make it sufficiently difficult for vandals to remove or deface the display 16 as to thwart such activities. In this embodiment, the tire cover 12 covers tire 11, the whole assembly being affixed to vehicle 10 by mounting means 18, and the cover being held in place on the tire by ties 13. Affixed as shown to cover 12 is the transparent repository pouch or pocket 14′, affixed by suitable means described above. An opening 20, such as a slot or a slit, extends from inside the cover 12 into the space formed in the repository 14′, into which the display 16 is inserted through the opening 20. Thus, passers-by, for example, have no easy access, externally, to the display 16.

FIG. 5 depicts, in elevation, partly broken away, and taken substantially along line 5-5 of FIG. 4, the combination cover-repository-display according to the invention. Therein, the display 16 is shown inserted through slot 20 into the transparent pouch or pocket 14′, all affixed to the tire cover 12 by suitable means 22, depicted schematically, which means 22 can include adhesives, thermal welding, various mechanical means, or any other suitable attachment means.

FIG. 6 shows one display 16′ having a familiar sports logo 17′.

FIG. 7 shows one display 16″ having a humorous phrase 17″ thereon.

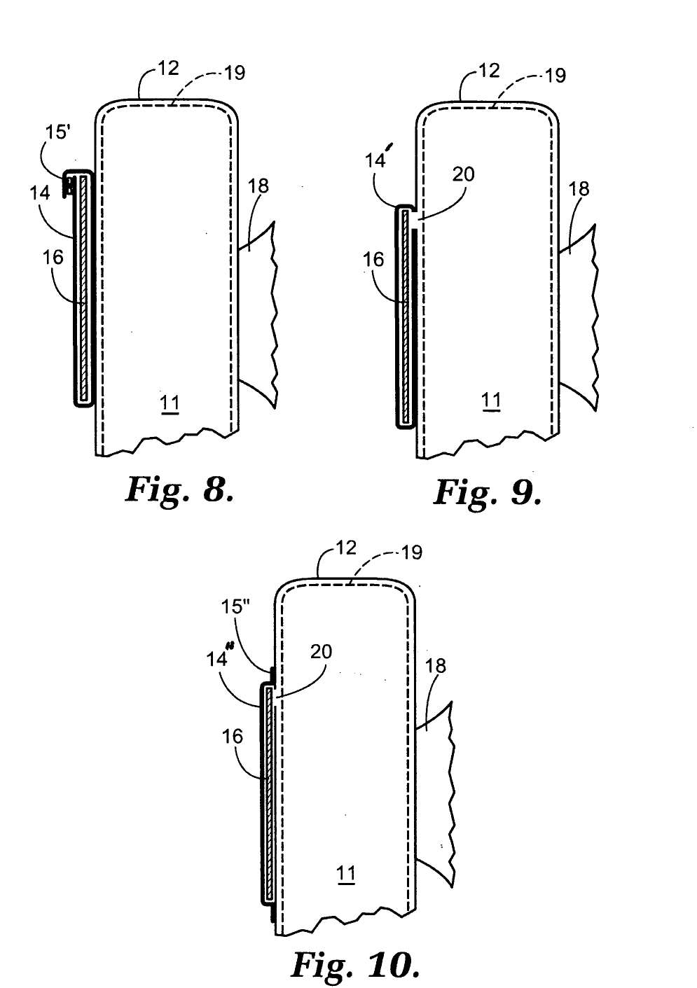

FIGS. 8, 9 and 10 depict alternate, possible, but in no way limitative, embodiments of the cover-repository-display of the invention, for comparisons side-by-side. FIG. 8 shows an envelope repository 14 having a securable flapped closure such as a zippered flap 15′. Other well-known closures may be employed such as the “zip lock” used on plastic freezer bags, or “Velcro” hook and loop type closures, all known to those skilled in the art.

FIG. 9 is substantially identical to FIG. 4, and illustrates access into pouch 14′ only through slot 20 from the inside of cover 12. And FIG. 10 depicts a further embodiment, perhaps the simplest configuration to produce in quantity, wherein a single transparent panel 14″ is affixed to cover 12 by suitable adhesive or thermal or other means at peripheral, integral flange-like extensions 15″ extending peripherally around the panel 14″ as shown, with display 16 being inserted into the pouch or pocket therein through slot 20 from inside the cover 12.

While the invention has been disclosed herein in connection with certain embodiments and detailed descriptions, it will be clear to one skilled in the art that modifications or variations of such details can be made without deviating from the gist of this invention, and such modifications or variations are considered to be within the scope of the claims hereinbelow.

What is claimed is:

1. A cover for an externally mounted spare tire for a vehicle, said cover having a repository affixed thereto, said repository having at least one opening thereinto and at least one transparent window therein, and optionally including a removable graphic display which, upon placement within said repository, said graphic display is displayed externally of said vehicle through said transparent window.

2. The cover-repository-display combination of claim 1 wherein said repository is an envelope having at least one transparent panel, said envelope being affixed to said cover externally thereof such that said display is removably insertable into said envelope through said opening therein.

3. The combination of claim 2 wherein said envelope is adhesively affixed to said cover.

4. The combination of claim 2 wherein said envelope is affixed to said cover by mechanical means.

5. The combination of claim 2 wherein said envelope is affixed to said cover by thermal weld means.

6. The combination of claim 1 wherein said transparent window is formed of a single transparent panel affixed externally to said cover about the periphery of said panel, said panel forming a type of pocket repository in said cover.

7. The combination of claim 6 wherein said panel is adhesively affixed to said cover.

8. The combination of claim 6 wherein said panel is affixed to said cover by mechanical means.

9. The combination of claim 6 wherein said panel is affixed to said cover by thermal weld means.

10. The cover-repository-display combination of claim 1 wherein said repository is formed of at least one transparent panel externally affixed to said cover about the entire periphery of said panel, and said cover has an opening therein positioned within the peripheral boundary of said panel, which opening extends from the inside of said cover into the repository formed between said external transparent panel and said cover, and which opening permits removable insertion of said display into said repository.

11. The combination of claim 10 wherein said opening is a slit.

12. The combination of claim 10 wherein said opening is a slot.

13. The combination of claim 1 wherein said opening has a closure therefor.

14. The combination of claim 6 wherein said opening has a closure therefor.

15. The combination of claim 10 wherein said opening has a closure therefore.

16. The combination of claim 13 wherein said closure is a zippered closure.

17. The combination of claim 14 wherein said closure is a zippered closure.

18. The combination of claim 15 wherein said closure is a zippered closure.

19. The cover-repository-display combination of claim 1 wherein said transparent window is constructed of transparent plastic.

20. The combination of claim 19 wherein said plastic is a plastic selected from the group consisting of polyethylene, polypropylene, vinyl, acrylic and polyester plastics.

21. The cover-repository-display combination of claim 1 wherein said display is fixed on a placard which is removably insertable into said repository.

22. The combination of claim 21 wherein said display is at least partially reflective.

23. The combination of claim 21 wherein said display is at least partially fluorescent.

24. The combination of claim 21 wherein said placard is of a size capable of printing indicia thereon on a home PC printer.

25. The combination of claim 24 wherein said placard is 11 inches by 17 inches or less in size.

26. The cover-repository-display combination of claim 1 wherein said graphic display carries an informative theme.

27. The cover-repository-display combination of claim 1 wherein said graphic display carries a political theme.

28. The cover-repository-display combination of claim 1 wherein said graphic display carries a sports theme.

29. The cover-repository-display combination of claim 1 wherein said graphic display carries an automotive theme.

30. The cover-repository-display combination of claim 1 wherein said graphic display carries a humorous theme.

31. The cover-repository-display combination of claim 1 wherein said graphic display carries a religious theme.

32. The cover-repository-display combination of claim 1 wherein said graphic display is a photographic display.

33. The combination of claim 21 wherein said placard is constructed of heavy gage plastic having indicia printed thereon.

34. The combination of claim 21 wherein said placard is constructed of cardboard having indicia printed thereon.

35. The combination of claim 21 wherein said placard is constructed of heavy weight paper having indicia printed thereon.

36. The cover-repository-display of claim 1 wherein said graphic display is a two-dimensional representation of anything which is capable of being depicted in two dimensions.

37. The cover-repository-display of claim 1, said cover having a repository affixed thereto, said repository having at least one opening thereinto and at least one transparent window therein, and including a graphic display which, upon placement within said repository, said graphic display is displayed externally of said vehicle through said transparent window.
